(19) United States
(12) Patent Application Publication
(10) Pub. No.: US 2023/0134034 A1
(43) Pub. Date: May 4, 2023

(54) METHOD FOR EVALUATING WASTE PLASTIC-DERIVED POROUS CARBON AND METHOD FOR MANUFACTURING POROUS CARBON

(71) Applicants: Korea University Research and Business Foundation, Seoul (KR); UNIST (Ulsan National Institute of Science and Technology), Ulsan (KR)

(72) Inventors: Yong Sik OK, Seoul (KR); Han Kwon LIM, Ulsan (KR); Boris BRIGLJEVIC, Ulsan (KR); Xiangzhou YUAN, Seoul (KR); Dong Hyun YU, Seoul (KR); Shauhrat S. CHOPRA, Hong Kong (CN)

(73) Assignees: Korea University Research and Business Foundation, Seoul (KR); UNIST (Ulsan National Institute of Science and Technology), Ulsan (KR)

(21) Appl. No.: 17/975,237

(22) Filed: Oct. 27, 2022

(30) Foreign Application Priority Data
Oct. 29, 2021 (KR) 10-2021-0146937

(51) Int. Cl. B01D 53/30; B01D 53/04; B01J 20/20; B01J 20/28; B01J 20/30

(52) U.S. Cl. CPC B01D 53/30; B01D 53/0462; B01J 20/20; B01J 20/28054; B01J 20/3078; B01D 2253/102; B01D 2256/10; B01D 2257/504; B01J 2220/4812

(57) ABSTRACT

An evaluation method capable of evaluating whether or not waste plastic-derived porous carbon can be applied on an industrial scale, according to the present disclosure, may include the steps of evaluating CO₂ capture performance using a 5-step temperature vacuum swing adsorption (TVSA) process, assessing economic feasibility in an industry using a techno-economic assessment (TEA) method, and quantifying environmental impacts of the porous carbon production pathway and global warming potential (GWP) using cradle-to-gate life-cycle assessment (LCA).

A method for manufacturing porous carbon, according to the present disclosure, may include the steps of carbonizing a polyethylene terephthalate plastic, activating the carbonized plastic with CO₂, and performing cooling.

### CROSS-REFERENCE TO RELATED APPLICATION

This present application claims the benefit of priority to Korean Patent Application No. 10-2021-0146937, entitled “Evaluation method of porous carbon derived from waste plastic and method of manufacturing porous carbon for CO₂ capture” filed on Oct. 29, 2021, in the Korean Intellectual Property Office, the entire disclosure of which is incorporated herein by reference.

### FIELD

The present disclosure relates to a method for evaluating waste plastic-derived porous carbon and a method for manufacturing porous carbon. Specifically, the present disclosure relates to a method for evaluating waste plastic-derived porous carbon, which can evaluate whether or not waste plastic-derived porous carbon can be applied on an industrial scale, and a method for manufacturing porous carbon capable of capturing CO₂.

### BACKGROUND

Since carbon dioxide emissions clearly contribute to global warming caused by the greenhouse gas effect, there is no doubt that the increase in atmospheric carbon dioxide concentration is one of the most important problems for humans today.

Currently, the concentration of carbon dioxide in the atmosphere exceeds 400 ppm, and continues to increase while continuously consuming enormous amounts of fossil fuels to meet the growing energy demand.

Fossil fuels are still major sources of energy for industrial facilities such as power plants, and carbon dioxide emitted from these sources accounts for about one-third of total carbon dioxide emissions. The gas emitted from the power plant contains about 5 to 20% of carbon dioxide and is discharged at a temperature of 40 to 70° C.

In order to solve the problem of global warming caused by greenhouse gas emissions, carbon dioxide capture and storage (CCS) technology is attracting attention, and this refers to a technology and technology groups that can capture CO₂ generated from fuel combustion or industrial processes.

Absorption, adsorption, membrane separation, and cryogenic methods have been developed as technologies for separating and capturing greenhouse gases. Adsorption among these capture methods is regarded as a promising technique, showing the advantages of mild operating conditions, scale-up possibility, and low energy requirements for adsorbent regeneration.

For CO₂ capture based on adsorption, several porous solid adsorbents including activated carbon, zeolites, mesoporous silica, and new types of hybrid crystalline solids have been developed. Recently, research has been conducted to prepare a conventional porous solid adsorbent at a lower cost.

Meanwhile, the disposal of plastic waste is a global problem and the demand for technologies to reuse or upgrade plastic waste is increasing.

Plastics are used in various places since they are light, flexible, moisture-resistant, and relatively inexpensive. The increase in plastic consumption corresponds to both of traditional plastics and new plastic composites along with major applications in the fields of packaging, building, automotive, electrical and electronic products, and agriculture.

It was reported in 2016 that 56 million tons of polyethylene terephthalate (PET) were produced annually, and it is estimated that most PET products were disposed of in landfills or at sea.

Since PET is not biodegradable, only photodegradable, PET waste breaks down into smaller microplastic fragments over time. Microplastics derived from PET waste can exist in aquatic and marine ecosystems and eventually ingest and accumulate by living things including humans.

Therefore, waste plastic-derived porous carbon for CO₂ capture may provide a solution to these two environmental problems. However, it remains unclear whether or not these new approaches will be implemented on an industrial scale globally.

### SUMMARY

An aspect of the present disclosure is to provide an evaluation method capable of evaluating whether or not waste plastic-derived porous carbon can be applied on an industrial scale and a method for manufacturing porous carbon.

An evaluation method capable of evaluating whether or not waste plastic-derived porous carbon can be applied on an industrial scale, according to the present disclosure, may include the steps of: evaluating CO₂ capture performance using a 5-step temperature vacuum swing adsorption (TVSA) process; assessing economic feasibility in an industry using a techno-economic assessment (TEA) method; and quantifying environmental impact of the porous carbon production pathway and global warming potential (GWP) using cradle-to-gate life-cycle assessment (LCA).

A method for manufacturing porous carbon, according to the present disclosure, may include the steps of: carbonizing a polyethylene terephthalate plastic; activating the carbonized plastic with different agents such as CO₂, KOH, Urea.

Using the evaluation method according to the present disclosure, waste plastic-derived porous carbon capable of mitigating climate change and promoting recycling of waste plastics through CO₂ capture can be evaluated and compared from various angles, and selected rationally in terms of aspects of CO₂ capture performance, economic feasibility, and environmental sustainability.

It can be confirmed that porous carbon manufactured by the manufacturing method according to the present disclosure has both of the lowest environmental impact and high economic benefits for industrial scale application when evaluated by the evaluation method according to the present disclosure. In other words, porous carbon physically activated with CO₂ is economically feasible and has low environmental impact.

### BRIEF DESCRIPTION OF THE DRAWINGS

FIG. 1 is a schematic diagram of a 5-step temperature vacuum swing adsorption (TVSA) process.

FIG. 2 is changes in temperature and pressure with time of the TVSA processor.

FIG. 3A is SEM images of porous carbon according to Examples, FIG. 3B is X-ray photoelectron spectrum irradiation results, FIG. 3C is Raman spectra, FIG. 3D is N₂ adsorption/desorption isothermal lines, and FIG. 3E is pore size distributions.

FIG. 4A is a graph of CO₂ adsorption performance of PET6-CO₂-9, FIG. 4B is a graph of CO₂ adsorption performance of PET6-K7, FIG. 4C is a graph of CO₂ adsorption performance of PET6-KU7, FIG. 4D is a graph of isosteric heats of adsorption (Qₛₜ), FIG. 4E is dynamic CO₂ adsorption test results, and FIG. 4F is ten periodic CO₂ adsorption test results using thermogravimetric analysis (TGA) at 30° C. and 1 bar.

FIG. 5A is a comparison result for each environmental impact category, and FIG. 5B is a result of considering a mitigated environment impact.

FIG. 6, as a diagram showing the environmental impacts and economic benefits of three samples, compares the global warming potential (GWP) and net present value (NPV).

FIG. 7 is results of comparing mitigated GWP and released GWP.

### DETAILED DESCRIPTION

Unless defined otherwise, all technical and scientific terms used in the present specification have the same meaning as commonly understood by one of ordinary skill in the art to which the present disclosure pertains. In general, the nomenclature used in the present specification is those well-known and commonly used in the art.

Hereinafter, the present disclosure will be described in more detail with reference to the accompanying drawings.

The present disclosure, which relates to a method for evaluating waste plastic-derived porous carbon, relates to a method for evaluating feasibilities such as whether or not waste plastic-derived porous carbon can be applied on an industrial scale and whether or not it is sustainable and economically feasible.

Specifically, the method for evaluating waste plastic-derived porous carbon according to various embodiments of the present disclosure may include the steps of: evaluating CO₂ capture performance using a 5-step temperature vacuum swing adsorption (TVSA) process; assessing economic feasibility in an industry using a techno-economic assessment (TEA) method; and quantifying environmental impacts of the porous carbon production pathway and global warming potential (GWP) using the cradle-to-gate life-cycle assessment (LCA).

The steps are not constrained in order and may be evaluated regardless of the order.

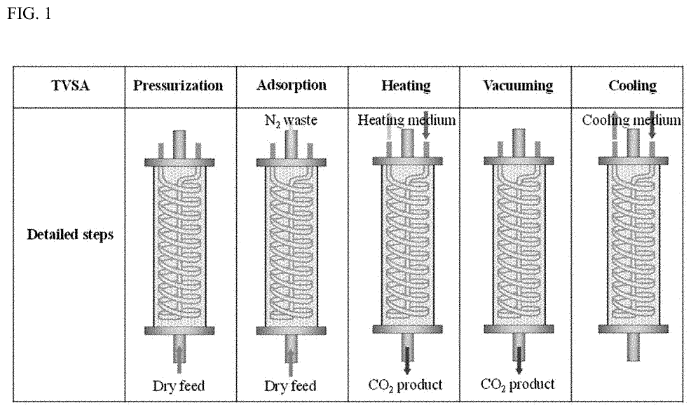

First, the step of evaluating the CO₂ capture performance using a five-step temperature vacuum swing adsorption (TVSA) process may be performed as the process as shown in FIG. 1. The TVSA process has the advantages that mild operating conditions for adsorbent regeneration that may be driven by low grade thermal solar energy are required, and it has high CO₂ productivity.

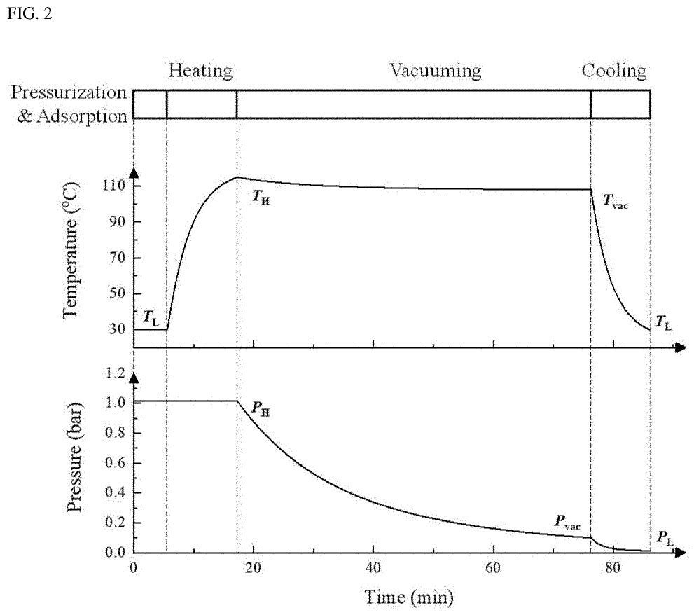

Specifically, referring to FIGS. 1 and 2, the five-step temperature vacuum swing adsorption process may be included of: (1) a pressurization step in which a feed gas (CO₂/N₂) flows into one port of an adsorption chamber at a constant velocity (v_{f}); (2) an adsorption step in which the feed gas is flown in at a constant velocity (v_{f}) from one port of the adsorption chamber and the other port is opened; (3) a heating step in which a desorbed gas (CO₂) is flown out from one port of the adsorption chamber and the other port is closed; (4) a vacuuming step in which the desorbed gas (CO₂) is discharged from one port of the adsorption chamber by a vacuum pump and the other port is closed; and (5) a cooling step in which both ports are closed and gas does not flow inside and outside the adsorption chamber.

(1) In the pressurization step, when the other port is closed, the pressure inside the chamber rises from a low value (P_{L}) to a high value (P_{H}). The heat of adsorption is removed by the cooling medium so that the chamber is maintained at a constant temperature (T_{L}).

(2) In the adsorption step, the pressure inside the chamber is maintained at a constant value P_{H}. In addition, the heat of adsorption is removed by the cooling medium so that the chamber is maintained at a constant temperature T_{L}.

(3) In the heating step, the pressure inside the chamber is maintained at a constant value P_{H}. Further, the adsorption chamber is heated by the heating medium to reach the desorption temperature T_{H}.

(4) In the vacuuming step, the pressure inside the chamber is reduced due to the continuous operation of the vacuum pump to achieve the vacuum pressure P_{vac}. The temperature of the adsorption chamber is slightly decreased and maintained at a constant temperature T_{vac}.

(5) In the cooling step, when the temperature drops, the pressure inside the closed adsorption chamber is further reduced to achieve the desorption pressure P_{L}. The adsorption chamber is cooled by the cooling medium to reach the adsorption temperature T_{L}.

Productivity, purity, recovery, specific energy consumption, and exergy efficiency may be derived and evaluated using such a TVSA process.

At this time, the specific energy consumption may be calculated by Equation below.

$$E = {w}_{vac} + {q}_{heat} ( \frac{{T}_{heat} - {T}_{cool}}{{T}_{heat}} )$$

where, w_{vac} (specific work consumption) is the work consumed by the vacuum pump in the (4) vacuuming step, and is calculated by Equation below.

$${w}_{vac} = \frac{{n}_{vac}}{{N}_{{CO}_{2} , des}} \frac{22.4}{{η}_{vac}} \frac{k}{k - 1} {P}_{H} [ {( \frac{{P}_{H}}{{P}_{vac}} )}^{\frac{k - 1}{k}} - 1 ]$$

Where, k and η_{vac} are the adiabatic coefficient of air and the efficiency of the vacuum pump respectively, and are 1.4 and 0.7 respectively.

where, qₕₑₐₜ is the heat provided in the (3) heating step and is calculated as follows.

$${Q}_{heat} = ( 1 - ε ) {V}_{bed} [ {C}_{p , ad} ( {T}_{H} - {T}_{L} ) + {ρ}_{ad} ( Δ {n}_{{CO}_{2} , des} Δ {H}_{1} + Δ {n}_{{N}_{3} , des} Δ {H}_{2} ) ]$$

$$+ {V}_{wall} {C}_{p , w} ( {T}_{H} - {T}_{L} )$$

$${q}_{heat} = \frac{{Q}_{heat}}{{N}_{{CO}_{2} , des} {M}_{{CO}_{2}}}$$

where, C_{p,ad} is the bed heat capacity, C_{p,w} is the chamber wall heat capacity, and M_{CO2} is the molar mass of CO₂.

Exergy efficiency, as an energy level, may be calculated by Equation below.

Eₑₓ=wₘᵢₙ/E

where, Wₘᵢₙ is the Gibbs free energy change (ΔG) as a minimum separation work for CO₂ separation, and is calculated as in Equation below.

Wₘᵢₙ=ΔGₛₑₚ=ΔG_{B}+ΔG_{C}−ΔG_{A}

The Gibbs free energy change for CO₂ separation (ΔGₛₑₚ) is calculated from the Gibbs free energy (ΔG_{A}) of the flue gas containing CO₂ emitted from the CO₂ emission plant, the Gibbs free energy (ΔG_{B}) of the CO₂ rich gas captured through the CO₂ capture plant, and the Gibbs free energy (ΔG_{C}) of the remaining flue gas. Meanwhile, E is the specific energy consumption described above.

In the step of assessing economic feasibility in the industry using the TEA method, it is characterized by performing evaluation using the revenue (R_{PC}) obtained from porous carbon according to Equation below and the revenue (R_{E}) obtained from electricity.

Specifically, the revenue (R_{PC}) obtained from porous carbon may be calculated as follows.

R_{PC}=Σₜ₌₁ⁿQ_{PC}×SP_{PC},

Where, R_{PC} is the revenue obtained from porous carbon, Q_{PC} is the amount (tons) of porous carbon produced, and SP_{PC} is the selling price (in Euros) of porous carbon per ton.

The revenue (R_{E}) obtained from electricity may be calculated as follows.

R_{E}=Σₜ₋₁ⁿU_{E}×FiT_{E},

Where, R_{E} is the revenue obtained from electricity generated by the combined heat and power (CHP) plant, U_{E} is the number of power (1%, 10%, 20%, 50%, and 75%) generated in kWh unit with respect to the power conversion rate after considering heat loss, and FiT_{E} is a supply tariff with respect to electricity units in Europe.

The step of quantifying environmental impacts of the porous carbon production pathway and global warming potential (GWP) using the cradle-to-gate life-cycle assessment (LCA) may use a ReCiPe (H) impact assessment method.

In the present disclosure, it may be possible to evaluate the environmental impact in the porous carbon activation process and the economic benefit for industrial scale application through TEA and LCA evaluation.

That is, using the evaluation method according to the present disclosure, waste plastic-derived porous carbon capable of mitigating climate change and promoting recycling of waste plastics through CO₂ capture can be evaluated and compared from various angles, and selected rationally in terms of aspects of CO₂ capture performance, economic feasibility, and environmental sustainability.

The method for manufacturing porous carbon according to the present disclosure may manufacture waste plastic-derived porous carbon capable of mitigating climate change and promoting recycling of waste plastics through CO₂ capture. Specifically, the present disclosure may include the steps of: carbonizing a polyethylene terephthalate (PET) plastic; activating the carbonized plastic using different agents such as CO₂, KOH, Urea.

In the carbonization step, PET may be cut into small pieces (about 5 mm×5 mm) and carbonized at 500° C. to 700° C. for 30 minutes to 2 hours in N₂ atmosphere.

Next, in the activation step, it may be activated by supplying CO₂ at a flow rate of 100 mL/min to 300 mL/min at a temperature of 800° C. to 1,000° C.

In the cooling step, it may be cooled by lowering the temperature to room temperature.

It can be confirmed that porous carbon manufactured by the manufacturing method according to the present disclosure has both of the lowest environmental impact and high economic benefits for industrial scale application when evaluated by the above-described evaluation method according to the present disclosure. In other words, porous carbon physically activated with CO₂ is economically feasible and has low environmental impact.

Hereinafter, the present disclosure will be described in more detail through Examples. These Examples are for illustrating the present disclosure in more detail, and the scope of the present disclosure is not limited to these Examples.

### EXAMPLE 1

### Manufacturing of PET Plastic-Derived Porous Carbon

As a raw material for porous carbon, polyethylene terephthalate PET bottles were collected from our daily environment (i.e., trash cans, streets). Before carrying out carbonization and activation/modification, the bottle caps and labels were removed, and then the bottles were washed, dried, and cut into small pieces (about 5 mm×5 mm) to pretreat the bottles. One whole PET sample was carbonized at 600° C. for 1 hour in N₂ atmosphere using a horizontal cylindrical furnace. The carbonized sample was named “PET6”, and it was prepared with three porous carbons using different activation methods.

### EXAMPLE 1-1

### Physical Activation Using CO₂

After 5 g of PET6 was put in a horizontal tubular reactor (50 mm inner diameter), the reactor was heated to 900° C. at a heating rate of 10° C./min, and held at 900° C. for 2 hours under a CO₂ flow rate of 200 mL/min. After the tubular reactor was cooled from the operating temperature to room temperature, the obtained sample was named “PET6-CO₂-9”.

### EXAMPLE 1-2

### Chemical Activation Using Potassium Hydroxide (KOH)

After a mixture (mass ratio of KOH:PET6 is 2:1) of 5 g of PET6 and 10 g of KOH was added to 25 mL of deionized water at 60° C. for 1 hour, the mixture was dried overnight at 110° C. to remove water. This dried mixture was further activated in a horizontal tubular reactor at a heating rate of 10° C./min at 700° C. for 1 hour under a N₂ flow rate of 200 mL/min, and then treated with 0.5 N HCl solution and removed. After drying it overnight at 110° C., a sample activated with KOH was collected and named “PET6K7”.

### EXAMPLE 1-3

### Simultaneous Activation Using KOH/Urea

Considering that effective N-doping may improve the adsorption and selectivity of CO₂ compared to other gases, N-doped porous carbon derived from waste PET plastic waste through one-pot synthesis was prepared. 5 g of PET6, KOH, and urea (mass ratio of PET6:KOH:urea is 1:2:1) were mixed with 25 mL of distilled water, and then the mixture was dried overnight at 110° C. to remove water. The dried mixture was activated at 700° C. at a heating rate of 10° C./min for 1 hour under a N₂ flow rate of 200 mL/min. The same washing and drying treatment as the previous activation method was applied and the final sample was named “PET6KU7”.

### EXAMPLE 2

### Morphological Analysis of Porous Carbon

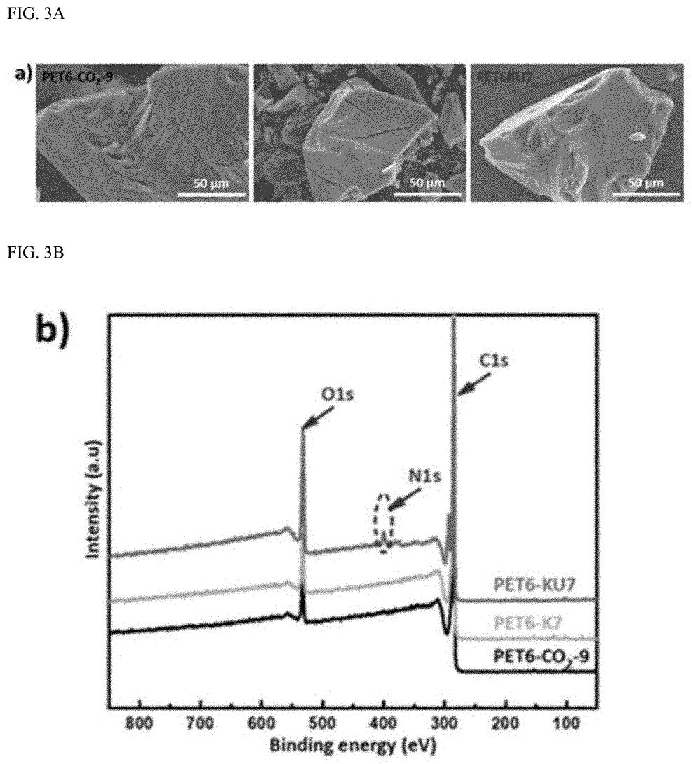

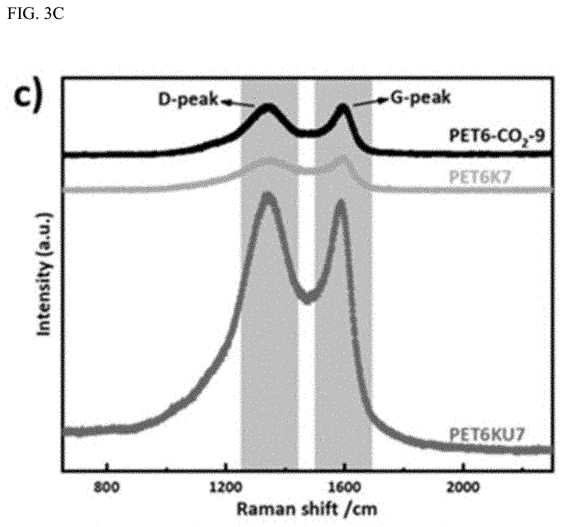

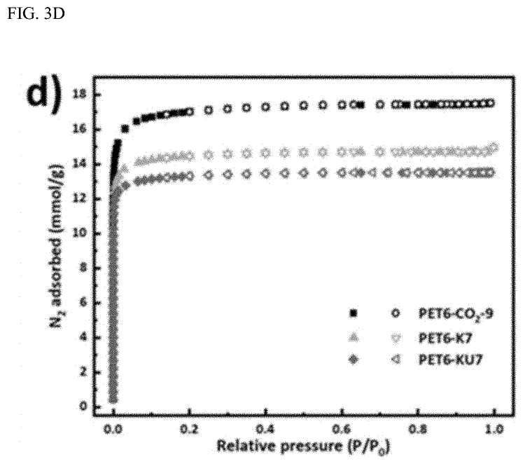

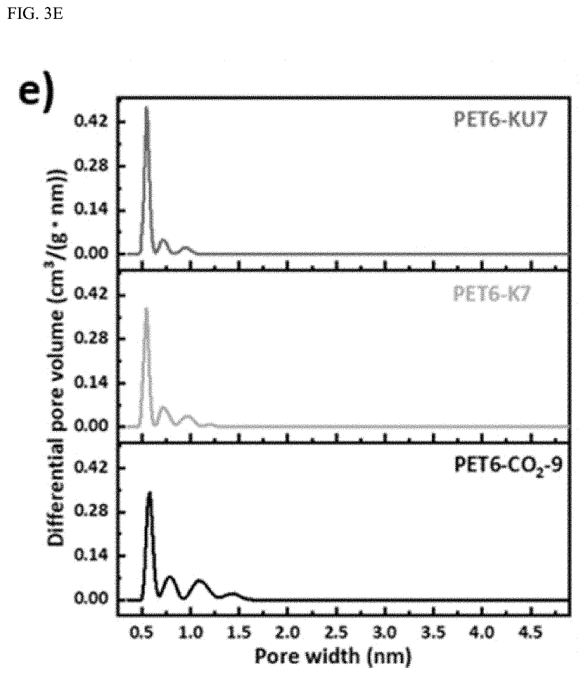

SEM images were checked with respect to Example 1-1 (PET6-CO₂-9), Example 1-2 (PET6K7), and Example 1-3 (PET6KU7), and as the results, it was confirmed that there was no obvious morphological difference between the three types of porous carbons referring to FIG. 3A.

Meanwhile, texture properties, XPS analysis, and CO₂ adsorption were compared with respect to three porous carbon samples, and the results are as shown in Table 1 below.

TABLE 1

| | | | | | | | | CO₂ uptake | | |
|---|---|---|---|---|---|---|---|---|---|---|
| | S_{BET}^{a} | Vₜₒₜₐₗ^{b} | | | Atomic (%)^{d} | | | (mmol/g)^{e} | | |
| Samples | m²/g | cm³/g | V_{micro}^{c} | V_{micro}/Vₜₒₜₐₗ | C | O | N | 0° C. | 25° C. | 50° C. |
| PET6-CO₂-9 | 1482 | 0.607 | 0.592 | 0.975 | 92.99 | 7.11 | — | 6.25 | 3.63 | 2.29 |
| PET6-K7 * | 1263 | 0.519 | 0.501 | 0.965 | 93.27 | 6.73 | — | 5.30 | 3.87 | 2.29 |
| PET6-KU7 * | 1165 | 0.469 | 0.460 | 0.981 | 77.97 | 18.80 | 3.23 | 6.23 | 4.58 | 2.82 |

^{a}Calculated using Brunauer-Emmett-Teller model.
^{b}Total pore volume at p/p₀ = 0.99 using Horvath-Kawazoe equation.
^{c}Micropore volume using Dubinin-Radushkevich Equation.
^{d}Peak area of X-ray photoelectron spectroscopy (XPS) spectra.
^{e}Acquired at less than 1 bar using a volumetric sorption analyzer.

Referring to Table 1 above and FIG. 3B, only PET6-KU7 among all samples showed an N content of 3.23% by weight to confirm that the N-doping treatment was effective. Referring to FIG. 3C, the D-peak at 1,350 cm⁻¹ and the G-peak at 1,589 cm⁻¹ were clearly observed in the Raman spectrum, and similar intensity ratios (I_{d}/I_{g}=˜1.0) of the D and G bands were obtained with respect to all three samples, which indicates that the degree of graphitization of the samples was not greatly different in different activation pathways. Referring to FIG. 3D, all N₂ adsorption and desorption isothermal lines were classified as type I according to the International Federation of Pure and Applied Chemistry classification system, suggesting that the prepared sample is a typical microporous carbon material. As shown in FIG. 3E, different peaks were detected for each sample, and it can be seen that micropores were well developed in all porous carbons. The dominant pore size was <1.5 nm, suitable for CO₂ capture.

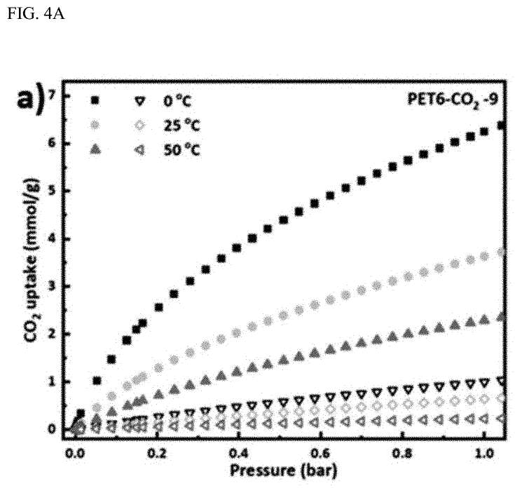

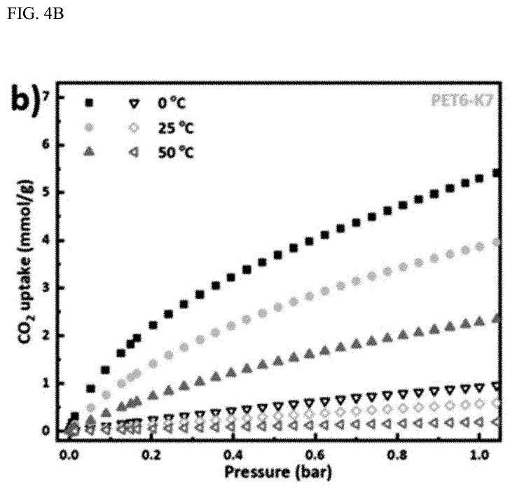

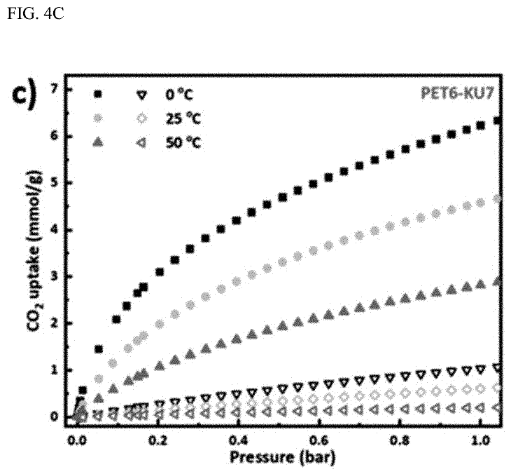

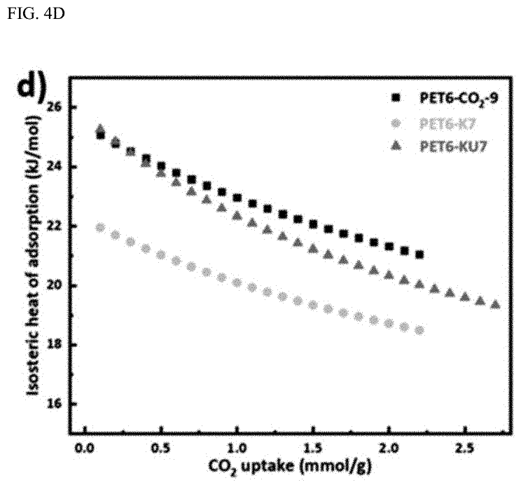

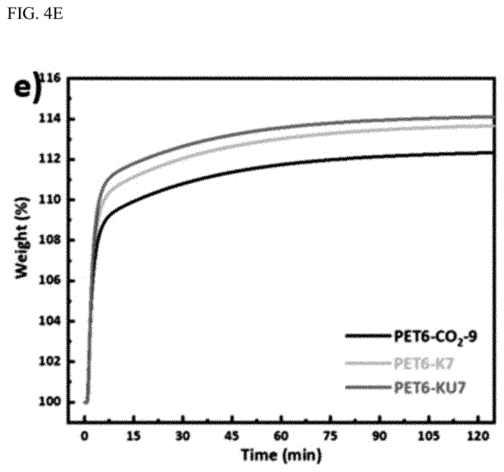

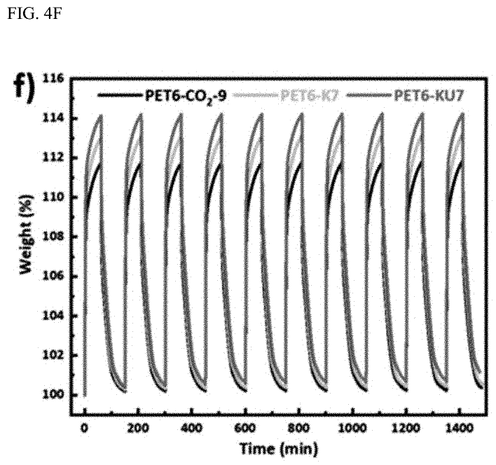

Referring to FIGS. 4A to 4C, the CO₂ adsorption performance values of three porous carbon samples were evaluated at 0 C, 25° C., and 50° C. at less than 1 bar, and the results are as shown in Table 1 above. Referring to FIG. 4D, the isosteric heat of adsorption (Qₛₜ) values were calculated using the Clausius-Clapeyron equation. ln(P) versus 1/T was indicated for the CO₂ adsorption isothermal lines obtained at 0, 25 and 50° C. for each sample. Referring to FIG. 4E, the dynamic CO₂ adsorption within 2 hours was evaluated using thermogravimetric analysis (TGA) at 30° C. and 1 bar. 95% or more of the total CO₂ uptake by each sample was achieved within the first 5 minutes, indicating rapid adsorption kinetics. Further, referring to FIG. 4F, the cycle stability of each sample was evaluated using 10 adsorption-desorption cycles at 30° C. and 1 bar. As a result, the same cycle curves of the CO₂ adsorption and desorption processes were obtained. In addition, stable working capacities of 2.68 mmol/g for PET6-CO₂-9, 3.03 mmol/g for PET6-K7, and 3.28 mmol/g for PET6-KU7 were observed. These are numerical values much higher than the absorption amount (1.5 mmol/g) of industrial MEA (aqueous monoethanolamine). In particular, they could be easily desorbed by converting the purge gas from the target gas to N₂.

### EXAMPLE 3

### TVSA Process Performance Evaluation

The periodic performance evaluation using the 5-step TVSA process of FIGS. 1 and 2 was performed 46 times. CO₂ gas was captured and separated from the mixed gas using a temperature and pressure driven adsorption and desorption process. Considering the adsorption chamber containing the CO₂ adsorbent and gas as a single system, a numerical simulation run in MATLAB (MathWorks, USA) was used to streamline the process to a steady-state process. This assumed that 1) the gas inside the adsorption chamber is an ideal gas and 2) the pressure drops throughout the adsorption chamber. In addition, 3) the mass transfer resistance between the solid and gas phases is negligible, 4) the temperature of the adsorption chamber was assumed to be homogeneous, and 5) the physical properties (specific heat capacity, density, and void fraction) of the system to be considered were assumed to remain constant.

Meanwhile, when selecting porous carbon with optimal CO₂ capture performance in terms of industrial applications and energy consumption, five key indicators including productivity, purity, recovery, specific energy consumption, and exergy efficiency were considered. Detailed operating parameters and simulation results are as shown in Table 2 below.

TABLE 2

| Operation parameters | Value | Unit |
|---|---|---|
| Heating medium temperature, Tₕₑₐₜ | 120 | ° C. |
| Cooling medium temperature, T_{cool} | 25 | ° C. |
| Heat transfer temperature difference | 5 | ° C. |
| Adsorption pressure, P_{H} | 1.0 | bar |
| Vacuuming pressure, P_{vac} | 0.1 | bar |

| Performance indicators | PET6-CO₂-9 | PET6-K7 | PET6-KU7 | |
|---|---|---|---|---|
| Productivity | 32.88 | 27.03 | 44.23 | kg/t h |
| Purity | 70.52 | 71.57 | 77.73 | % |
| Recovery | 89.88 | 84.93 | 90.02 | % |
| Specific energy consumption, E | 1.04 | 1.44 | 0.97 | GJ/t |
| Exergy efficiency, Eₑₓ | 7.21 | 5.06 | 8.94 | % |

Referring to Table 2 above, PET6-KU7 is shown to be considered as the most promising candidate for CO₂ capture from the point of view of industrial application and energy consumption compared with PET6-CO₂-9 and PET6-K7.

### EXAMPLE 4

### Evaluation of Economic feasibility in Industry Using TEA Method

Evaluation was performed on Example 1-1 (PET6-CO₂-9), Example 1-2 (PET6K7), and Example 1-3 (PET6KU7) in consideration of the total capital investment (TCI), yearly operation cost (YOC), and revenue which are generated for the scale-up process modeling.

First, the sum of the costs for manufacturing porous carbon was estimated in order to derive the total capital investment (TCI), and this was subdivided into various processes such as pretreatment, pyrolysis, carbon activation process, power generation, flue gas treatment, other costs, and infrastructure costs, and these are as shown in Table 3 below.

TABLE 3

| | Capacity | | | Cost | | | |
|---|---|---|---|---|---|---|---|
| | PET6- | PET6- | PET6- | PET6- | PET6- | PET6- | Reference |
| Equipment cost | CO₂-9 | K7 | KU7 | CO₂-9 | K7 | KU7 | or Source |

Waste PET Pre-treatment Cost

| Weighbridges | 50 t | €21,500.00 | ^{S27} |
|---|---|---|---|
| Feedstock store | 1500 t | €5,680.50 | ^{S28} |
| Belt conveyer system | 10 m | €1,700.00 | * |
| Shredder | 1 t | €7,682.40 | ^{S29} |
| Trommel screen | 1 t | €18,000.00 | * |
| with conveyers | | | |
| Loading shovels | 0.5 t | €11,250.00 | * |
| Excavator | 0.5 t | €11,250.00 | * |
| Sub-total: 1 (ST1) | | €77062.90 | — |

Pyrolysis Unit

| Auger screw-flue gas | 1 t/h | | €799,044.80 | | ^{S30} |
|---|---|---|---|---|---|
| heated pyrolizer with | | | | | |
| vapour collection | | | | | |
| Auger conveyor belt | 5 m | | €840.00 | | * |
| Horizontal belt | 3 motors | 5 motors | €360.00 | €600.00 | * |
| conveyors motors | | | | | |
| Sub-total: 2 (ST2) | | | €800,244.80 | €800,484.80 | — |

Carbon Activation Process

| Activation reactor | 0.11 t | | | €3,200.00 | | | * |
|---|---|---|---|---|---|---|---|
| KOH solution storage tank | 15 t | | | €780.00 | | | * |
| Urea solution storage tank | 6 t | | | €320.00 | | | * |
| HCL solution storage tank | 20 t | | | €1,040.00 | | | * |
| Mixing tank | — | 1 t | 2 t | — | €3,500.00 | €7,000.00 | * |
| Dryer | | 2 | | — | €8,000.00 | | * |
| Washer | — | 1 | | — | €5,000.00 | | * |
| Silo/Bin (Porous carbon | 2.5 t | | | €1,600.00 | | | * |
| storage) | | | | | | | |
| Sub-total: 3 (ST3) | | | | €6,940.00 | €23,440.00 | €26,940.00 | — |

Power Generation

| | | | |
|---|---|---|---|
| High pressure turbine | 306.6 kW | €246,636.00 | ^{S27} |
| Medium pressure turbine | 347.8 kW | €280,326.80 | ^{S27} |
| Low pressure turbine | 614.6 kW | €495,367.50 | ^{S27} |
| Organic Rankine cycle | 95.4 kW + 5 t (Working fluid) | €571,323.62 | ^{S31, S32}, *^{a} |
| turbine | | | |
| Water chiller unit | 5 t/h | €5,725.00 | * |
| Cold water storage tank | 150 t | €30,750.00 | * |
| Sub-total: 4 (ST4) | 1341.97 kW | €1,630,128.92 | — |

Flue gas treatment €20,388.62

| Pressure swing adsorption | 1 unit (20 kg/h to 300 kg/h) | €203,950.00 | * |
|---|---|---|---|
| unit and associated | | | |
| components | | | |
| Sub-total: 5 (ST5) | | €203,950.00 | — |

Miscellaneous expenses

| Additional machinery | — | €82,950.00 | ^{S33} |
|---|---|---|---|
| Sub-total: 6 (ST6) | | €82,950.00 | — |
| Infrastructure costs | | | |

| Land cost | 12,000 m² at €93.60/m² | €1,123,200.00 | Estimated |
|---|---|---|---|
| Office and laboratory | — | €400,000.00 | ^{S33} |
| equipment | | | |
| Buildings | — | €200,000.00 | Estimated |
| Sub-total: 7 (ST7) | | €1,723,200.00 | — |

| | | | | | |
|---|---|---|---|---|---|
| Total Capital Investment | — | €4,524,476.62 | €4,541,186.61 | €4,544,716.62 | — |
| (TCI) = | | | | | |
| ST1 + ST2 + ST3 + | | | | | |
| ST4 + ST5 + ST6 + ST7 | | | | | |

* indicates data from https://www.alibaba.com/. All values are converted from RMB to euro to represent a conversion ratio of RMB 1 = €0.13 (a is the cost value of the working fluid).

Referring to Table 3, it was confirmed that the total capital investments (TCI) for Example 1-1 (PET6-CO₂-9), Example 1-2 (PET6K7), and Example 1-3 (PET6KU7) were similar.

Meanwhile, the yearly operation cost (YOC) was estimated after considering the input of raw materials required for manufacturing Example 1-1 (PET6-CO₂-9), Example 1-2 (PET6K7), and Example 1-3 (PET6KU7). The recurring costs of carbon and other infrastructure overhead required to sustain a production unit are presented in Table 4 below. Operational data were obtained according to process requirements. Energy consumption amount was the most commonly required input amount and was supplied internally through the CHP plant. The net exergy efficiency of the CHP system was low in such an amount that the costs associated with energy consumption were not negligible. Cost data related to consumables, particularly cost data used in the activation process, were obtained through Alibaba, an Internet company having long-term contracts with suppliers.

Water required for the power generation process was supplied monthly by a Tianjin industrial water supplier at a price of RMB 7.9/t (Price Monitoring Center, NDRC) S34. In the case of yearly operation costs, the costs accompanied by capturing the emitted CO₂ emissions were also priced taking into account the cost values for the purchased porous carbon.

TABLE 4

| | Capacity | | | Cost | | | Reference |
|---|---|---|---|---|---|---|---|
| Equipment cost | PET6-CO₂-9 | PET6-K7 | PET6-KU7 | PET6-CO₂-9 | PET6-K7 | PET6-KU7 | or Source |

Carbon Activation Process

| CO₂ gas | 1.05 t/h | — | — | 0.00 ^{a} | — | — | — |
|---|---|---|---|---|---|---|---|
| KOH | — | 0.421 t/h | | — | €232.00 | | * |
| Urea | — | — | 0.23 t/h | — | — | €57.00 | * |

| | | | | | |
|---|---|---|---|---|---|
| HCL | — | 0.8 t/h | — | €174.67 | * |

| | | | | | |
|---|---|---|---|---|---|
| Sub-total: 8 (ST8) ^{c} | Estimated per year | — | €3,253,360.00 | €3,709,360.00 | — |

Power Generation

| | | | |
|---|---|---|---|
| Water | 3.9 t/h | €3.89 | ^{S34} |
| Sub-total: 9 (ST9) ^{c} | Estimated per year | €31,120.00 | — |

Flue Gas Treatment

| Energy | Energy from the combined heat and power plant within the system boundary | | | | | | |
|---|---|---|---|---|---|---|---|
| Capture cost for | 76 t | 66 t | 46 t | €95,852.16 | €83,005.56 | €57,852.36 | Estimated |
| plant emission ^{b} | | | | | | | |
| Sub-total: 10 (ST10) | | | | €95,852.16 | €83,005.56 | €57,852.36 | — |

Human Resource

| | | | |
|---|---|---|---|
| Workforce includes plant | Salaries and other expenses | €126,096.17 | Estimated |
| operators, administrative | for 15 people per year | | |
| team etc. | | | |
| Sub-total: 11 (ST11) ^{c} | Estimated per year | €126,096.17 | — |

Miscellaneous Expenses ^{c}

| Maintenance | 6% of TCI | €271,468.59 | €272,471.19 | €272,682.99 | ³⁵ |
|---|---|---|---|---|---|
| Insurance | 2.5% of TCI | €113111.92 | €113,529.67 | €113,617.92 | ³⁶ |
| Contingencies | 5% of TCI | €226223.83 | €227,059.33 | €227,235.83 | ³⁷ |
| ICT infrastructure cost | Per year | €5,000.00 | | | Estimated |
| Sub-total: 12 (ST12) | Estimated per year | €615,804.34 | €618,060.19 | €618,536.74 | |
| First Year Operation | Estimated per year | €868,872.67 | €4,111,641.92 | €4,542,965.27 | — |
| Cost (FYOC) = ST8 + | (first year) | | | | |
| ST9 + ST10 + ST11 + S12 | | | | | |
| Yearly Operation | Estimated per year | €773,020.57 | €4,028,636.36 | €4,485,112.91 | — |
| Cost (YOC) = | (Second year onwards) | | | | |
| ST8 + S9 + ST11 + S12 | | | | | |

The CO₂ required for physical activation was obtained from a pressure swing adsorption (PSA) unit, one-time cost in the first year, yearly cost, and * represent data obtained from https://www.alibaba.com/;, and all values were converted to RMB 1=0.13 Euros.

Referring to Table 4, the yearly operation cost was evaluated to be the lowest in Example 1-1 (PET6-CO₂-9).

Next, in order to evaluate the revenue, the revenue obtained by selling porous carbon in the market and the revenue obtained by selling electricity were calculated according to Equation below.

$${R}_{PC} = {\sum }_{t = 1}^{n} {Q}_{PC} \times {SP}_{PC}$$

Where, R_{PC} is the revenue obtained from porous carbon, Q_{PC} is the amount (tons) of porous carbon produced, and SP_{PC} is the selling price (in Euros) of porous carbon per ton.

$${R}_{E} = {\sum }_{t = 1}^{n} {U}_{E} \times {FiT}_{E}$$

Where, R_{E} is the revenue obtained from electricity generated by the combined heat and power (CHP) plant, U_{E} is the number of power (1%, 10%, 20%, 50%, and 75%) generated in kWh unit with respect to the power conversion rate after considering heat loss, and FiT_{E} is a supply tariff with respect to electricity units in Europe.

TR is the total revenue obtained by selling porous carbon and electricity, and is calculated using Equation below.

Meanwhile, revenue generation (in euro unit) through the sale of porous carbon is as shown in Table 5 below.

TABLE 5

| | | | | Revenue (when sold | | | Revenue (when sold | |
|---|---|---|---|---|---|---|---|---|
| | Porous carbon (ton) | | | at the minimum price) | | | at an average price) | |
| | PET6- | PET6- | PET6- | PET6- | PET6- | PET6- | PET6- | PET6- |
| Year | CO₂-9 | K7 | KU7 | CO₂-9 | K7 | KU7 | CO₂-9 | K7 |
| 1 | 704 | 800 | 720 | 201,555.20 | 229,040.00 | 206,136.00 | 1,107,494.08 | 1,259,716.00 |
| 2 | 704 | 800 | 720 | 201,555.20 | 229,040.00 | 206,136.00 | 1,107,494.08 | 1,259,716.00 |
| 3 | 704 | 800 | 720 | 201,555.20 | 229,040.00 | 206,136.00 | 1,107,494.08 | 1,259,716.00 |
| 4 | 704 | 800 | 720 | 201,555.20 | 229,040.00 | 206,136.00 | 1,107,494.08 | 1,259,716.00 |
| 5 | 704 | 800 | 720 | 201,555.20 | 229,040.00 | 206,136.00 | 1,107,494.08 | 1,259,716.00 |
| 6 | 704 | 800 | 720 | 201,555.20 | 229,040.00 | 206,136.00 | 1,107,494.08 | 1,259,716.00 |
| 7 | 704 | 800 | 720 | 201,555.20 | 229,040.00 | 206,136.00 | 1,107,494.08 | 1,259,716.00 |
| 8 | 704 | 800 | 720 | 201,555.20 | 229,040.00 | 206,136.00 | 1,107,494.08 | 1,259,716.00 |
| 9 | 704 | 800 | 720 | 201,555.20 | 229,040.00 | 206,136.00 | 1,107,494.08 | 1,259,716.00 |
| 10 | 704 | 800 | 720 | 201,555.20 | 229,040.00 | 206,136.00 | 1,107,494.08 | 1,259,716.00 |
| 11 | 704 | 800 | 720 | 201,555.20 | 229,040.00 | 206,136.00 | 1,107,494.08 | 1,259,716.00 |
| 11 | 704 | 800 | 720 | 201,555.20 | 229,040.00 | 206,136.00 | 1,107,494.08 | 1,259,716.00 |
| 13 | 704 | 800 | 720 | 201,555.20 | 229,040.00 | 206,136.00 | 1,107,494.08 | 1,259,716.00 |
| 14 | 704 | 800 | 720 | 201,555.20 | 229,040.00 | 206,136.00 | 1,107,494.08 | 1,259,716.00 |
| 15 | 704 | 800 | 720 | 201,555.20 | 229,040.00 | 206,136.00 | 1,107,494.08 | 1,259,716.00 |
| Life | 10,560 t | 12,000 t | 10,800 t | €3,023,328.00 | €3,435,600.00 | €3,092,040.00 | €16,612,411.20 | €18,895,740.00 |
| time | | | | | | | | |

| | Revenue (when sold | Revenue (when sold | | |
|---|---|---|---|---|
| | at an average price) | at the maximum price) | | |
| | PET6- | PET6- | PET6- | PET6- |
| Year | KU7 | CO₂-9 | K7 | KU7 |
| 1 | 1,133,744.40 | 2,015,544.96 | 2,290,392.00 | 2,061,352.80 |
| 2 | 1,133,744.40 | 2,015,544.96 | 2,290,392.00 | 2,061,352.80 |
| 3 | 1,133,744.40 | 2,015,544.96 | 2,290,392.00 | 2,061,352.80 |
| 4 | 1,133,744.40 | 2,015,544.96 | 2,290,392.00 | 2,061,352.80 |
| 5 | 1,133,744.40 | 2,015,544.96 | 2,290,392.00 | 2,061,352.80 |
| 6 | 1,133,744.40 | 2,015,544.96 | 2,290,392.00 | 2,061,352.80 |
| 7 | 1,133,744.40 | 2,015,544.96 | 2,290,392.00 | 2,061,352.80 |
| 8 | 1,133,744.40 | 2,015,544.96 | 2,290,392.00 | 2,061,352.80 |
| 9 | 1,133,744.40 | 2,015,544.96 | 2,290,392.00 | 2,061,352.80 |
| 10 | 1,133,744.40 | 2,015,544.96 | 2,290,392.00 | 2,061,352.80 |
| 11 | 1,133,744.40 | 2,015,544.96 | 2,290,392.00 | 2,061,352.80 |
| 11 | 1,133,744.40 | 2,015,544.96 | 2,290,392.00 | 2,061,352.80 |
| 13 | 1,133,744.40 | 2,015,544.96 | 2,290,392.00 | 2,061,352.80 |
| 14 | 1,133,744.40 | 2,015,544.96 | 2,290,392.00 | 2,061,352.80 |
| 15 | 1,133,744.40 | 2,015,544.96 | 2,290,392.00 | 2,061,352.80 |
| Life | €17,006,166.00 | €30,233,174.40 | €34,355,880.00 | €30,920,292.00 |
| time | | | | |

The revenue obtained by selling electricity was estimated by considering the heat loss scenario as shown in Table 6 below.

TABLE 6

| Parameters | PET6-CO₂-9 | | | | PET6-K7 | | | |
|---|---|---|---|---|---|---|---|---|
| Total Q | 1.00 | 10.00 | 20.00 | 50.00 | 75.00 | 1.00 | 10.00 | 20.00 |
| loss; % | | | | | | | | |
| Tfg | 1202.00 | 1185.00 | 1167.00 | 1113.00 | 1067.00 | 1259.00 | 1243.00 | 1225.00 |
| (Rankine | | | | | | | | |
| in); C | | | | | | | | |
| Rankine | 4010.00 | 3915.00 | 3810.00 | 3490.00 | 3220.00 | 3925.00 | 3845.00 | 3750.00 |
| H₂O; kg/h | | | | | | | | |
| Net; kW | 706.56 | 678.25 | 646.97 | 551.55 | 470.99 | 706.56 | 682.80 | 654.53 |
| Act Q; | −581.42 | −581.42 | −581.42 | −581.42 | −581.42 | −252.89 | −252.89 | −252.89 |
| MJ/h | | | | | | | | |
| Pyro Q; | −2859.14 | −2859.14 | −2859.14 | −2859.14 | −2859.14 | −2859.14 | −2859.14 | −2859.14 |
| MJ/h | | | | | | | | |
| Cooling | 4043.00 | 3971.00 | 3878.00 | 3623.00 | 3403.00 | 3983.00 | 3910.00 | 3831.00 |
| water; | | | | | | | | |
| kg/h | | | | | | | | |
| Act Q | −5.81 | −58.14 | −116.28 | −290.71 | −436.07 | −2.53 | −25.28 | −50.578 |
| Loss; | | | | | | | | |
| MJ/h | | | | | | | | |
| Pyro Q | −28.60 | −285.91 | −571.83 | −1429.57 | −2144.35 | −28.60 | −285.91 | −571.83 |
| Loss; | | | | | | | | |
| MJ/h | | | | | | | | |

| Parameters | PET6-K7 | | PET6-KU7 | | | | |
|---|---|---|---|---|---|---|---|
| Total Q | 50.00 | 75.00 | 1.00 | 10.00 | 20.00 | 50.00 | 75.00 |
| loss; % | | | | | | | |
| Tfg | 1170.00 | 1125.00 | 1245.00 | 1228.00 | 1208.00 | 11150.00 | 1100.00 |
| (Rankine | | | | | | | |
| in); C | | | | | | | |
| Rankine | 3460.00 | 3220.00 | 3850.00 | 3760.00 | 3655.00 | 3345.00 | 3085.00 |
| H₂O; kg/h | | | | | | | |
| Net; kW | 568.00 | 496.50 | 703.35 | 676.60 | 645.25 | 552.84 | 475.31 |
| Act Q; | −252.89 | −252.89 | −486.0596 | −486.06 | −486.06 | −486.06 | −486.06 |
| MJ/h | | | | | | | |
| Pyro Q; | −2859.14 | −2859.14 | −2859.136 | −2859.14 | −2859.14 | −12859.14 | −2859.14 |
| MJ/h | | | | | | | |
| Cooling | 3600.00 | 3411.00 | 3799.00 | 3712.00 | 3639.00 | 3385.00 | 3175.00 |
| water; | | | | | | | |
| kg/h | | | | | | | |
| Act Q | −126.45 | −189.68 | −4.86 | −48.61 | −97.22 | −243.03 | −364.55 |
| Loss; | | | | | | | |
| MJ/h | | | | | | | |
| Pyro Q | −1429.57 | −2144.35 | −28.59 | −285.91 | −571.83 | −1429.57 | −2144.35 |
| Loss; | | | | | | | |
| MJ/h | | | | | | | |

The results of calculating revenue generation by electricity sales are as shown in Table 7 below.

TABLE 7

| | Lifetime varying different heat loss percentage | | | | | |
|---|---|---|---|---|---|---|
| Sample | 0% | 1% | 10% | 20% | 50% | 75% |
| PET6-CO₂-9 | 85,200,000 | 84,787,200 | 81,390,000 | 77,636,400 | 66,186,000 | 56,518,800 |
| PET6-K7 | 87,988,800 | 84,787,200 | 81,936,000 | 78,543,600 | 68,160,000 | 59,580,000 |
| PET6-KU7 | 87,988,800 | 84,402,000 | 81,192,000 | 77,430,000 | 66,340,320 | 57,036,960 |

The results showed that PET6-CO₂-9 production was the most feasible process, followed by PET6-K7 and PET6-KU7 production. According to TEA results, all three of these pathways can produce porous carbon, energy loss during the process is 20%, and the product can be sold at the lowest market price (Euro 200/t).

### EXAMPLE 5

### Life Cycle Assessment (LCA) Method Evaluation

Cradle-to-gate LCA was evaluated on Example 1-1 (PET6-CO₂-9), Example 1-2 (PET6K7), and Example 1-3 (PET6KU7). Calculation was performed on the environmental impact categories of Table 8 below using the ReCiPe(H) Midpoint method of SimaPro(v8.5.2) software.

TABLE 8

| Impact category | Unit |
|---|---|
| Global warming | kg CO₂ eq |
| Stratospheric ozone depletion | kg CFC11 eq |
| Ionising radiation | kBq Co-60 eq |
| Ozone formation, human health | kg NOₓ eq |
| Fine particulate matter formation | kg PM_{2.5} eq |
| Ozone formation, terrestrial ecosystems | kg NOₓ eq |
| Terrestrial acidification | kg SO₂ eq |
| Freshwater eutrophication | kg P eq |
| Marine eutrophication | kg N eq |
| Terrestrial ecotoxicity | kg 1,4-DCB |
| Freshwater ecotoxicity | kg 1,4-DCB |
| Marine ecotoxicity | kg 1,4-DCB |
| Human carcinogenic toxicity | kg 1,4-DCB |
| Human non-carcinogenic toxicity | kg 1,4-DCB |
| Land use | m2a crop eq |
| Mineral resource scarcity | kg Cu eq |
| Fossil resource scarcity | kg oil eq |
| Water consumption | m³ |

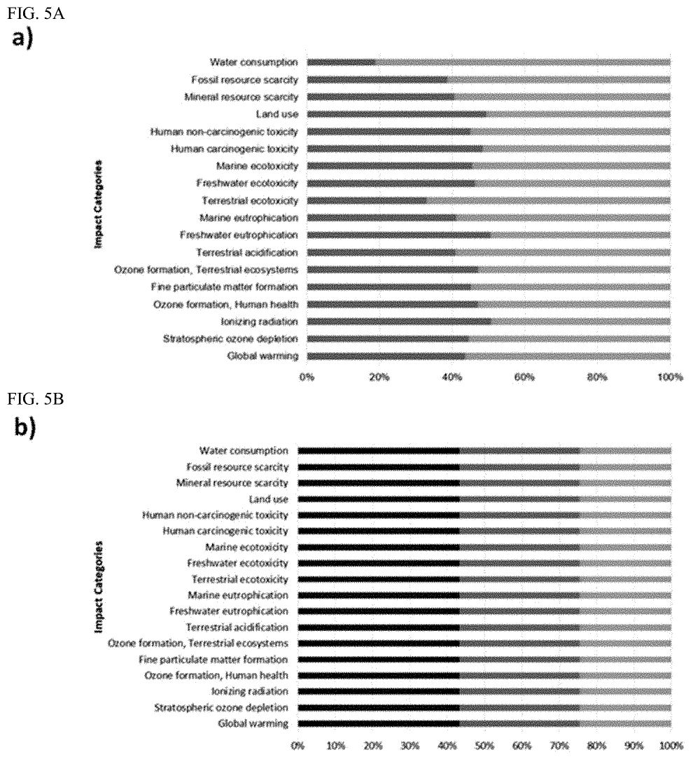

As results, referring to FIG. 5A, it was shown that the KOH/urea chemical activation pathway that is Example 1-3 (PET6KU7) had a greater environmental impact in almost all 18 environmental impact categories. That is, Example 1-3 (PET6KU7) was about 200% higher than the CO₂ physical activation pathway that is Example 1-1 (PET6-CO₂-9), and was −1.74% to 125% higher than the KOH chemical activation pathway that is Example 1-2 (PET6K7). FIG. 5B is a result of considering a mitigated environment impact.

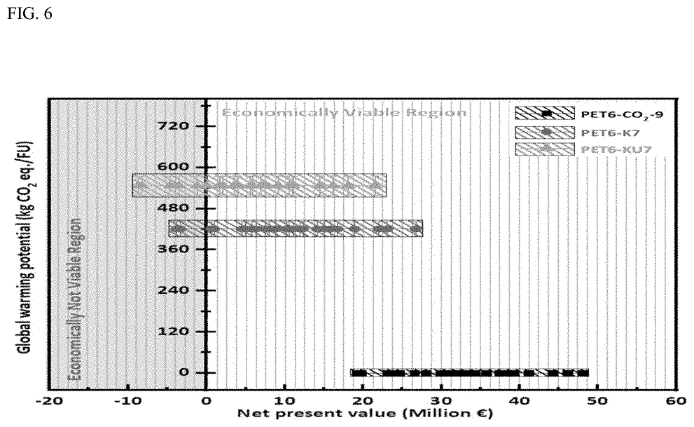

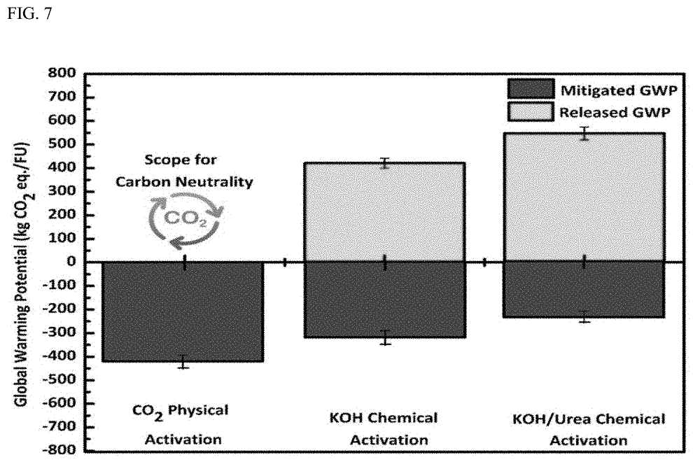

Meanwhile, GWP among all impact categories is the most important. Referring to FIGS. 6 and 7, the CO₂ physical activation pathway that is Example 1-1 (PET6-CO₂-9) had the lowest GWP, and the KOH/urea chemical activation pathway that is Example 1-3 (PET6KU7) had the highest GWP.

Referring to FIG. 6, a net present value (NPV) was calculated for the production of each porous carbon in various scenarios by changing the heat-power conversion loss and the selling price of porous carbon. Each scenario describes the capital investment in the plant, operating costs over 15 years, and revenue obtained from the sale of porous carbon and electricity produced in the process. As results, PET6-CO₂-9 production was shown to be the most feasible process, followed by PET6-K7 and PET6-KU7 production. When the TEA result evaluated in Example 4 above and the LCA result of Example 5 above were integrated and evaluated, it was confirmed that the CO₂ physical activation pathway that is Example 1-1 (PET6-CO₂-9) had both of the lowest environmental impact and high economic benefits for industrial scale application. That is, it was confirmed that Example 1-1 (PET6-CO₂-9) was economically feasible and had a low environmental impact.

Hereinabove, a specific part of the present disclosure content has been described in detail. Therefore, it will be clear to those of ordinary skill in the art that this specific description is only a preferred embodiment, and the scope of the present disclosure is not limited thereby. Accordingly, the substantial scope of the present disclosure will be said to be defined by the appended claims and their equivalents.

What is claimed is:

1. A method for evaluating waste plastic-derived porous carbon, the method comprising the steps of:
evaluating CO₂ capture performance using a 5-step temperature vacuum swing adsorption (TVSA) process;
assessing economic feasibility in an industry using a techno-economic assessment (TEA) method; and
quantifying environmental impacts of the porous carbon production pathway and global warming potential (GWP) using cradle-to-gate life-cycle assessment (LCA).

2. The method of claim 1, wherein the five-step temperature vacuum swing adsorption process is included of:
(1) a pressurization step in which a feed gas (CO₂/N₂) flows into one port of an adsorption chamber at a constant velocity (v_{f});
(2) an adsorption step in which the feed gas is flown in at a constant velocity (v_{f}) from one port of the adsorption chamber and the other port is opened;
(3) a heating step in which a desorbed gas (CO₂) is flown out from one port of the adsorption chamber and the other port is closed;
(4) a vacuuming step in which the desorbed gas (CO₂) is discharged from one port of the adsorption chamber by a vacuum pump and the other port is closed; and
(5) a cooling step in which both ports are closed and gas does not flow inside and outside the adsorption chamber, and
the five-step temperature vacuum swing adsorption process is used to derive and evaluate productivity, purity, recovery, specific energy consumption, and exergy efficiency.

3. The method of claim 2, wherein the specific energy consumption is calculated by Equation below:
$$E = {w}_{vac} + {q}_{heat} ( \frac{{T}_{heat} - {T}_{cool}}{{T}_{heat}} )$$
where, w_{vac} (specific work consumption) is a work consumed by the vacuum pump in the (4) vacuuming step, and is calculated by Equation below:
$${w}_{vac} = \frac{{n}_{vac}}{{N}_{{CO}_{2} , des}} \frac{22.4}{{η}_{vac}} \frac{k}{k - 1} {P}_{H} [ {( \frac{{P}_{H}}{{P}_{vac}} )}^{\frac{k - 1}{k}} - 1 ]$$
where, k and η_{vac} are an adiabatic coefficient of air and an efficiency of the vacuum pump respectively, and are 1.4 and 0.7 respectively, and
where, qₕₑₐₜ is a specific heat input in the (3) heating step and is calculated as follows:
$${Q}_{heat} = ( 1 - ε ) {V}_{bed} [ {C}_{p , ad} ( {T}_{H} - {T}_{L} ) + {ρ}_{ad} ( Δ {n}_{{CO}_{2} , des} Δ {H}_{1} + Δ {n}_{{N}_{3} , des} Δ {H}_{2} ) ]$$
$$+ {V}_{wall} {C}_{p , w} ( {T}_{H} - {T}_{L} )$$
$${q}_{heat} = \frac{{Q}_{heat}}{{N}_{{CO}_{3} , des} {M}_{{CO}_{3}}}$$
where, M_{CO2} is a molar mass of CO₂.

4. The method of claim 2, wherein the exergy efficiency is calculated by Equation below:
Eₑₓ=wₘᵢₙ/E
where, Wₘᵢₙ is a Gibbs free energy change (ΔG) as a minimum separation work for CO₂ separation, and E is specific energy consumption.

5. The method of claim 1, wherein in the step of assessing economic feasibility in the industry using the TEA method, evaluation is performed using a revenue (R_{PC}) obtained from porous carbon according to Equation below and a revenue (R_{E}) obtained from electricity:
R_{PC}=Σₜ₌₁ⁿQ_{PC}×SP_{PC},
where, R_{PC} is the revenue obtained from porous carbon, Q_{PC} is an amount (tons) of porous carbon produced, and SP_{PC} is a selling price (in Euros) of porous carbon per ton, and
R_{E}=Σₜ₌₁ⁿU_{E}×FiT_{E},
where, R_{E} is the revenue obtained from electricity generated by a combined heat and power (CHP) plant, U_{E} is the number of power (1%, 10%, 20%, 50%, and 75%) generated in kWh unit with respect to a power conversion rate after considering heat loss, and FiT_{E} is a supply tariff with respect to electricity units in Europe.

6. The method of claim 1, wherein the step of quantifying the porous carbon production pathway and global warming potential (GWP) using the cradle-to-gate life-cycle assessment (LCA) uses a ReCiPe (H) impact assessment method.

7. A method for manufacturing porous carbon, the method comprising steps of:
carbonizing a polyethylene terephthalate plastic;
activating the carbonized plastic with CO₂; and
performing cooling.

8. The method of claim 7, wherein in the step of performing activation with CO₂, the activation is performed at a temperature of 800° C. to 1,000° C.

9. The method of claim 7, wherein in the step of performing activation with CO₂, CO₂ is supplied at 100 mL/min to 300 mL/min.
